(19) United States
(12) Patent Application Publication
(10) Pub. No.: US 2024/0286509 A1
(43) Pub. Date: Aug. 29, 2024

(54) DC-DC VEHICLE CHARGER

(71) Applicant: Tigo Energy, Inc., Campbell, CA (US)

(72) Inventors: Daniel Eizips, Sunnyvale, CA (US); Idan Avrutsky, Alfei Menashe (IL); Shmuel Arditi, Discovery Bay, CA (US)

(21) Appl. No.: 18/582,321

(22) Filed: Feb. 20, 2024

Related U.S. Application Data
(60) Provisional application No. 63/487,533, filed on Feb. 28, 2023.

(51) Int. Cl. B60L 53/51; B60L 55/00

(52) U.S. Cl. CPC B60L 53/51; B60L 55/00; B60L 2210/10; B60L 2210/40

(57) ABSTRACT

A system may include a charging station configured to charge an electric vehicle. The charging station includes a DC input configured to receive a DC input power. The charging station includes a DC output configured to be connected to an electric vehicle. The charging station is a DC-DC charging station.

### CROSS-REFERENCE TO RELATED APPLICATIONS

This application claims priority to U.S. Provisional Application No. 63/487,533, entitled “DC-DC VEHICLE CHARGER” and filed on Feb. 28, 2023, the entire contents of which are hereby incorporated by reference.

### FIELD OF THE TECHNOLOGY

At least some embodiments disclosed herein relate generally to vehicle charging. More specifically, the embodiments relate to vehicle charging stations that receive a direct current (DC) input and provide a DC output.

### BACKGROUND

Electric vehicles include a power source (e.g., a battery or batteries) onboard the electric vehicle. Buildings are being equipped with charging stations to charge the batteries onboard the electric vehicle from the power source of the buildings. Some charging stations are unidirectional and some are bidirectional. In a unidirectional charging station, power can be provided from the building's power source to the electric vehicle. In a bidirectional charging station, power can be provided from the building's power source to the electric vehicle; power can be provided from the power source onboard the electric vehicle to the building, for example, during a power outage, and used to power systems of the building; or can be provided to the grid. Unidirectional and bidirectional charging stations can be standalone structures as well, for example, an installation on a pole, carport, or some other shade structure.

Many buildings utilize photovoltaic systems. Some of these buildings also include charging stations for electric vehicles. Often, the photovoltaic system and the charging station operate independently. In many configurations, the photovoltaic system can generate power which is transformed to an alternating current (AC). The charging station can receive AC power from an inverter of the photovoltaic system, the grid, or some other AC power source such as a generator. Thus, the charging station converts the AC input to a DC output, which is then provided to the batteries onboard the electric vehicle.

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIG. 1 shows a schematic diagram of a power system, according to some embodiments.

FIG. 2 shows a schematic diagram of a power system, according to some embodiments.

FIG. 3 shows a schematic diagram of a power system, according to some embodiments.

FIG. 4 shows a schematic diagram of a charging station, according to some embodiments.

FIG. 5 shows a schematic diagram of a charging station, according to some embodiments.

### DETAILED DESCRIPTION

The present disclosure relates to vehicle charging. More specifically, the embodiments relate to vehicle charging stations that receive a direct current (DC) input and provide a DC output. In some embodiments, the DC input may be from an inverter, a maximum power point tracker (MPPT) photovoltaic device, or other DC power source. In some embodiments, the charging stations may have an increased efficiency and can be built at a lower cost.

Electric vehicles include a power source (e.g., a battery) onboard the electric vehicle. Buildings are being equipped with charging stations to charge the power source onboard the electric vehicle from the power source of the buildings. Some charging stations are unidirectional and some are bidirectional. In a unidirectional charging station, power can be provided from the building's power source to the electric vehicle. In a bidirectional charging station, power can be provided from the building's power source to the electric vehicle or power can be provided from the power source onboard the electric vehicle to the building and used to power systems of the building.

Embodiments of this disclosure relate to a charging station and corresponding power system in which the charging station receives a DC input and provides a DC output. In some embodiments, the charging station can be configured to receive either a DC or an AC input depending on the capabilities of the power source and its ability to supply either an AC output or a DC output. That is, the embodiments relate to charging stations in which a conversion from an AC input to a DC output can be avoided.

In some embodiments, the inverter and the charging station can be integrated into a single device. In some embodiments, this can further improve efficiency and reduce costs of the charging station. In some embodiments, the power system includes both a photovoltaic system and a charging station for an electric vehicle. In some embodiments, the photovoltaic system and the charging station utilize a single power converter. In some embodiments, the single power converter is an inverter for the photovoltaic system. In such embodiments, the charging station can be connected to a DC line of the inverter or to another DC power source. In some cases, the inverter may be replace by a solar MPPT device. In such embodiments, the connection between the inverter and the charging station can reduce a requirement of converting an AC input to a DC output by the charging station, which can, for example, increase efficiency and reduce costs.

In some embodiments, the power system can reduce a number of AC to DC conversions compared to prior systems. In some embodiments, the power system can eliminate AC to DC conversions altogether. In some embodiments, reducing the number of AC to DC conversions can reduce an amount of losses due to conversion, thus improving an overall efficiency of the power system. In some embodiments, the reduction in the number of conversions can increase a reliability of the power system. In some embodiments, the reduction can also reduce a cost of the charging station.

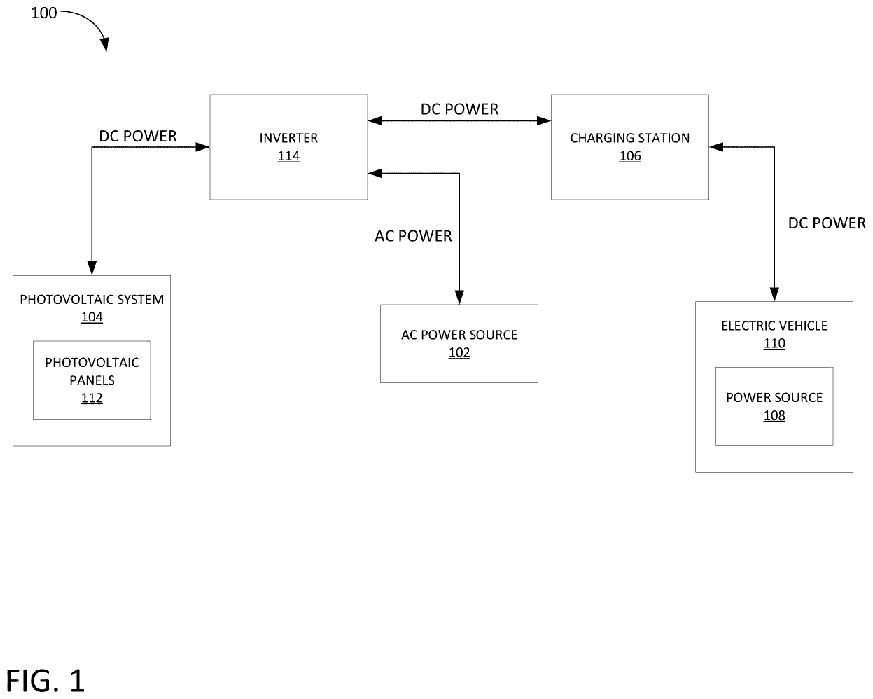

FIG. 1 shows a schematic diagram of a power system 100, according to some embodiments. In some embodiments, the power system 100 is capable of supplying a DC power signal to charge an electric vehicle or to supply power to a grid connection (e.g., as received from a photovoltaic system or a power source of an electric vehicle).

In the illustrated embodiment, the power system 100 includes an optional AC power source 102, a photovoltaic system 104, and a charging station 106. The charging station 106 is configured to provide a DC power output to charge a power source 108 onboard an electric vehicle 110.

The AC power source 102 can be representative of a power grid. In some embodiments, the AC power source 102 can include a generator (e.g., a backup power generator). In some embodiments, the AC power source can include other power sources capable of outputting an AC power signal. In some cases there will be no AC power source in such configuration. In some cases, the AC power source can also be a recipient of power, for example a grid being a recipient of the solar generated power.

In the illustrated embodiment, the photovoltaic system 104 includes a plurality of photovoltaic panels 112. The photovoltaic system 104 is capable of generating energy that can be used to supply energy to the charging station 106 or to the grid (e.g., AC power source 102). It is to be appreciated that the photovoltaic system 104 can include additional components not described in detail in this Specification. The photovoltaic system 104 can be coupled with any building structure such as, but not limited to, a residential building, a commercial building, an industrial building, or the like.

In some cases, the DC power source can be a different power source than photovoltaic system. The photovoltaic system 104 is configured to output a DC power signal to an inverter 114. The inverter 114 can convert the DC power signal to an AC power signal and, for example, provide the AC power output from the inverter 114 back to the grid (e.g., AC power source 102). In some embodiments, the charging station 106 is connected via a DC line to the inverter 114 to receive a DC power signal from the inverter 114, which is then output as a DC power signal to the electric vehicle 110 for charging the power source 108 on board the electric vehicle 110. In some embodiments, the inverter 114 is the only inverter in the power system 100. That is, in some embodiments, the photovoltaic system 104 and the charging station 106 share the inverter 114.

In some embodiments, the charging station 106 can receive power from the photovoltaic system 104. In some embodiments, the power signal supplied from the photovoltaic system 104 can be a DC power signal that is provided to the charging station 106 without conversion between AC and DC. That is, the charging station 106 can be connected to the photovoltaic system 104 in such a manner that a power conversion is unnecessary. In some embodiments, the charging station 106 can receive power from the AC power source 102. In such embodiments, the AC power signal from the grid can be converted by the inverter 114 to a DC power signal.

In some embodiments, the charging station 106 is a bidirectional charging station capable of receiving power from the power source 108 onboard the electric vehicle 110 and providing the power to the inverter 114 and subsequently to the grid.

In some embodiments, the charging station 106 can be referred to as a DC-DC charging station since the charging station 106 receives a DC input signal and provides a DC output signal. In some embodiments, the charging station 106 can receive either a DC input signal or an AC input signal and provide a DC output signal.

In some embodiments, the inverter 114 is the only inverter for the photovoltaic system 104. In some embodiments, the inverter 114 is connected in electrical communication with both the photovoltaic system 104 and the charging station 106.

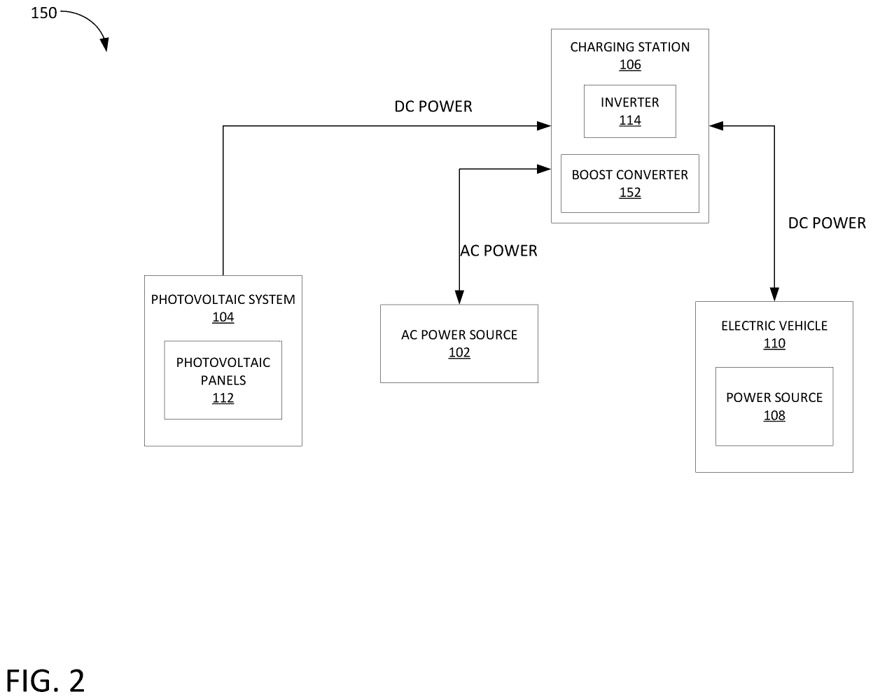

FIG. 2 shows a schematic diagram of a power system 150, according to some embodiments. For simplicity of this Specification, features of the power system 150 that have been previously described will not be re-described in additional detail.

The power system 150 includes the AC power source 102, the photovoltaic system 104, and the charging station 106. The power system 150 does not include a separate inverter (i.e., the inverter 114 in FIG. 1). Instead, the DC power output of the photovoltaic system 104 can be provided as an input to the charging station 106. In such embodiments, the charging station 106 can include inverter 114 onboard to convert AC power from the AC power source 102. In some embodiments, the charging station 106 can also include a boost converter 152. The boost converter 152 is configured to step-up, step down, or a combination thereof, the voltage from the photovoltaic system 104 prior to providing the output from the charging station 106 to the power source 108. In some embodiments, the boost converter 152 can improve an overall power efficiency provided by the power system 150 and increase the performance of the power system 150 compared to the power system 100.

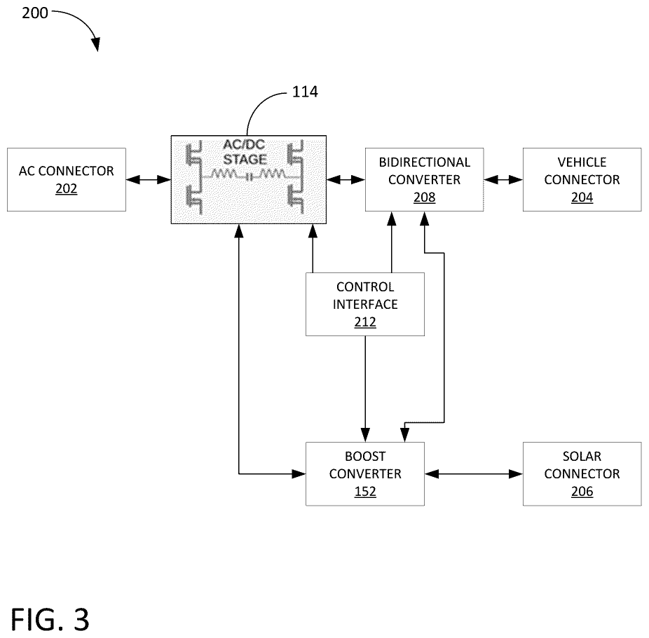

FIG. 3 shows a schematic diagram of a power system 200, according to some embodiments. For simplicity of this Specification, features of the power system 200 that have been previously described will not be re-described in additional detail.

The power system 200 includes an AC connector 202, a vehicle connector 204, and a solar connector 206. In some embodiments, all of the components of the power system 200 can be contained within a housing such that the unit can be installed at a location. In some embodiments, the AC connector 202 can be eliminated.

In some embodiments, the AC connector 202 can be configured to be connected to an AC power source (e.g., the AC power source 102 in FIG. 1).

In some embodiments, the vehicle connector 204 can be configured to be connected to an electric vehicle (e.g., the electric vehicle 110 in FIG. 1). In some embodiments, the vehicle connector 204 can be, for example, a combined charging system (CCS) connector or the like. It is to be appreciated that the particular type of connector for connecting to the electric vehicle is not intended to be limited.

In some embodiments, the solar connector 206 can be configured to receive a DC power input from a photovoltaic system (e.g., the photovoltaic system 104 in FIGS. 1-2). The DC input power can be provided from the photovoltaic system 104 or some other DC power source (e.g., batteries or the like) to the boost converter 152. As discussed above, it is to be appreciated that the boost converter 152 may not be included in the power system 200. In some embodiments, the DC power signal is then provided to the inverter 114 (optionally) or directly to the converter. The DC signal may be provided from the inverter 114 to a bidirectional converter 208. In some embodiments, the bidirectional converter 208 can be, for example, an LLC converter or the like. The bidirectional converter 208 provides a DC output power to the vehicle connector 204 and subsequently to the electric vehicle 110.

In some embodiments, for example, in case of a power outage, a DC power input from the vehicle connector 204 can be provided to the bidirectional converter 208. The DC power from the bidirectional converter 208 can be provided to the inverter 114. The inverter 114 can convert the DC power input received to an AC power output, and provide the AC power output to the AC connector 202 to, for example, power a building in which the power system 200 is used.

The power system 200 can include one or more additional features. For example, in the illustrated embodiment, the power system 200 includes a converter 210, a control interface 212, and a converter 214. In some embodiments, the converter 210 is in electrical communication with the inverter 114. In some embodiments, the control interface 212 is in electrical communication with the inverter 114, the boost converter 152, and the bidirectional converter 208. In some embodiments, the converter 214 is in electrical communication with the boost converter 152 and the bidirectional converter 208.

In some embodiments, the AC/DC stage may not be implemented. In some embodiments, the boost converter may be a buck or buck/boost converter. In some embodiments, the boost converter may be a buck or buck/boost converter. In some embodiments, the boost converter may be a buck or buck/boost converter. In some embodiments, the boost and bi-directional converter may be a single converter.

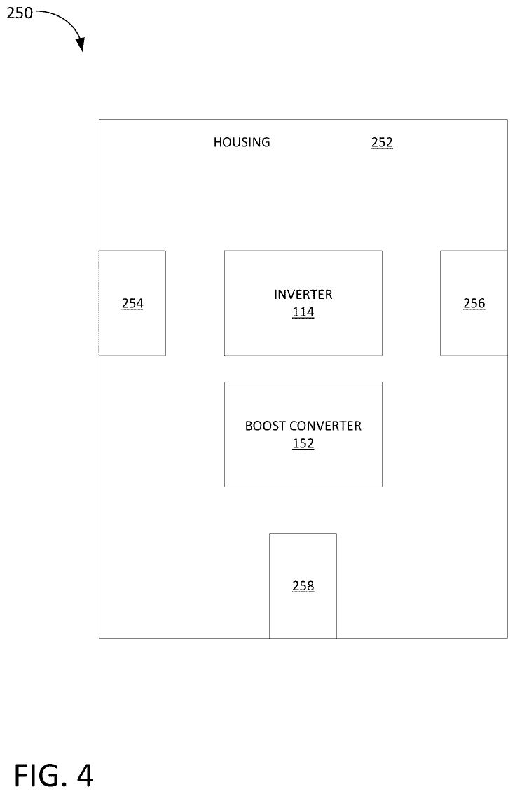

FIG. 4 shows a schematic diagram of a charging station 250, according to some embodiments. The charging station 250 can be a combination of the components of the power system 100, the power system 150, and the power system 200 in FIGS. 1-3 into a housing and used in the power system 100, the power system 150, or the power system 200.

In the illustrated embodiment, the charging station 250 includes the inverter 114 integrated in a housing 252. The boost converter 152 is also contained within the housing 252.

In some embodiments, the housing 252 includes a connector 254, a connector 256, and a connector 258. In some embodiments, the connector 254 is configured to be connected to an AC connection such as, but not limited to, AC power source 102. In some embodiments, the connector 256 is configured to be connected to the electric vehicle 110. In some embodiments, the connector 258 is configured to be connected to the photovoltaic system 104.

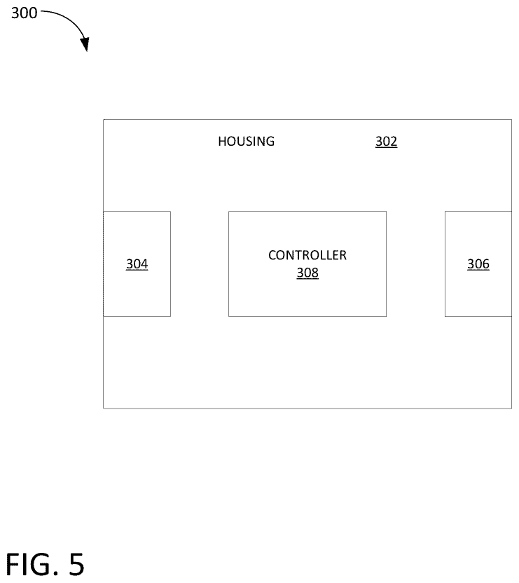

FIG. 5 shows a schematic diagram of a charging station 300, according to some embodiments. The charging station 300 can be used as the charging station 106 in FIGS. 1-3.

In the illustrated system, the charging station 300 includes a housing 302, a connector 304 and a connector 306. In some embodiments, the connector 304 is configured to be connected to a DC line of an inverter (e.g., the inverter 114 in FIGS. 1-3). In some embodiments, the connector 306 is configured to be connected to the electric vehicle 110.

It is to be appreciated that one or more additional components can be included such as, but not limited to, a controller 308 or the like for controlling the output from the charging station 300 to the electric vehicle 110.

In some embodiments, a system, including: a charging station configured to charge an electric vehicle, wherein the charging station includes: a DC input configured to receive a DC input power; a DC output configured to be connected to an electric vehicle; and wherein the charging station is a DC-DC charging station.

In some embodiments, a system, wherein the charging station is a bidirectional charging station configured to receive a second DC input power at the DC output and provide the second DC input power to an AC power source.

In some embodiments, a system, further including a photovoltaic system including a plurality of photovoltaic panels.

In some embodiments, a system, further including an inverter.

In some embodiments, a system, wherein the inverter is a single inverter configured to be connected in electrical communication with the photovoltaic system and the charging station, wherein the inverter is configured to output a DC output power to provide the DC input power for the charging station.

In some embodiments, a system, further including a boost converter connected in electrical communication with the photovoltaic system and the inverter.

In some embodiments, a system, wherein the inverter and the charging station are connected via a DC line.

In some embodiments, a system, wherein the inverter and the charging station are disposed within a housing.

In some embodiments, a charging station, including: a housing, including: a first connector configured to receive a DC input power; and a second connector configured to output a DC output power.

In some embodiments, a charging station, wherein the housing further includes a boost converter.

In some embodiments, a charging station, further including an inverter.

In some embodiments, a charging station, wherein the charging station is a bidirectional charging station.

In some embodiments, a charging station, wherein the housing includes an AC output connector configured to be connected to a power source.

In some embodiments, a charging station, wherein the housing includes a bidirectional converter.

In some embodiments, a charging station, wherein the first connector is configured to be connected to a photovoltaic system.

In some embodiments, a charging station, wherein the first connector is configured to be connected to an inverter of the photovoltaic system.

In some embodiments, a charging station, wherein the second connector is configured to be connected to a vehicle.

In some embodiments, a charging station, including: a DC input configured to receive a DC input power from an inverter of a photovoltaic system; and a DC output configured to be connected to an electric vehicle to provide a DC power output to the electric vehicle; wherein the charging station is a DC-DC charging station.

In some embodiments, a charging station, wherein the charging station is a bidirectional charging station.

In some embodiments, a charging station, further including a boost converter.

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

All prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

What is claimed is:

1. A system, comprising:
a charging station configured to charge an electric vehicle,
wherein the charging station comprises:
a DC input configured to receive a DC input power;
a DC output configured to be connected to an electric vehicle; and
wherein the charging station is a DC-DC charging station.

2. The system of claim 1, wherein the charging station is a bidirectional charging station capable of providing DC power from the electric vehicle to another DC unit.

3. The system of claim 1, wherein the charging station is a bidirectional charging station configured to receive a second DC input power at the DC output and provide the second DC input power to an AC power source.

4. The system of claim 3, further comprising an inverter or photovoltaic MPPT unit.

5. The system of claim 4, wherein the inverter is a single inverter configured to be connected in electrical communication with the photovoltaic system and the charging station, wherein the inverter is configured to output a DC output power to provide the DC input power for the charging station.

6. The system of claim 4, further comprising one of a buck converter, a boost converter, or a buck/boost converter connected in electrical communication with the photovoltaic system and the inverter.

7. The system of claim 4, wherein the inverter and the charging station are connected via a DC line.

8. The system of claim 4, wherein the inverter and the charging station are disposed within a housing.

9. A charging station, comprising:
a housing, comprising:
a first connector configured to receive a DC input power; and
a second connector configured to output a DC output power.

10. The charging station of claim 9, wherein the housing further comprises a buck/boost converter.

11. The charging station of claim 9, further comprising an inverter.

12. The charging station of claim 9, wherein the charging station is a bidirectional charging station.

13. The charging station of claim 9, wherein the housing comprises an AC output connector configured to be connected to a power source.

14. The charging station of claim 9, wherein the housing comprises a bidirectional converter.

15. The charging station of claim 9, wherein the first connector is configured to be connected to a photovoltaic system.

16. The charging station of claim 15, wherein the first connector is configured to be connected to an inverter of the photovoltaic system.

17. The charging station of claim 9, wherein the second connector is configured to be connected to a vehicle.

18. A charging station, comprising:
a DC input configured to receive a DC input power from an inverter of a photovoltaic system; and
a DC output configured to be connected to an electric vehicle to provide a DC power output to the electric vehicle;
wherein the charging station is a DC-DC charging station.

19. The charging station of claim 18, wherein the charging station is a bidirectional charging station.

20. The charging station of claim 18, further comprising a boost converter.
